(19) United States
(12) Patent Application Publication
(10) Pub. No.: US 2025/0339947 A1
(43) Pub. Date: Nov. 6, 2025

(54) POWER TOOL ASSEMBLY WITH IDENTIFICATION SCHEME AND AUTO SHUTOFF SCHEME

(71) Applicant: MILWAUKEE ELECTRIC TOOL CORPORATION, Brookfield, WI (US)

(72) Inventors: Evan M. Glanzer, Milwaukee, WI (US); Joseph W. Miller, Waukesha, WI (US); Patrick D. Gallagher, New Berlin, WI (US); Timothy J. Bartlett, Waukesha, WI (US); Jonathan Alejandro Gaona, Torreón (MX); Edgar Olguin Holguin, Torreón (MX); Rodolfo Jesús Silva Emiliano, Torreón (MX); Jorge Perez, Torreón (MX)

(21) Appl. No.: 19/192,937

(22) Filed: Apr. 29, 2025

Related U.S. Application Data
(60) Provisional application No. 63/642,092, filed on May 3, 2024.
(60) Provisional application No. 63/716,295, filed on Nov. 5, 2024.
(60) Provisional application No. 63/753,084, filed on Feb. 3, 2025.

(51) Int. Cl. B25F 5/02; H01M 50/247; H02J 7/00

(52) U.S. Cl. CPC B25F 5/029; H01M 50/247; H02J 7/0063

(57) ABSTRACT

A power supply configured to supply electrical power to a connected power tool having a motor and an identifier representative of a characteristic of the connected power tool. The power supply includes a housing with a battery receptacle configured to receive a battery pack and an electronic unit position within the housing. The electronic control unit can interface with the identifier to determine the characteristic of the connected power tool and, in response to the determined characteristic, supply electrical power from the battery pack to the motor at an associated power output.

### CROSS-REFERENCE TO RELATED APPLICATIONS

This application claims priority to U.S. Provisional Patent Application No. 63/753,084 filed on Feb. 3, 2025, U.S. Provisional Patent Application No. 63/716,295 filed on Nov. 5, 2024, and U.S. Provisional Patent Application No. 63/642,092 filed on May 3, 2024, the entire content of each of which is incorporated herein by reference.

### FIELD OF THE INVENTION

The present disclosure relates to a power supply for power tools, and more specifically to power supply control schemes.

### BACKGROUND OF THE INVENTION

Power tools operate within certain operating ranges of power supplied from a power supply to a motor thereof to operate properly. Depending on factors such as the size, capacity, and type of power tool, different operating ranges of power may be supplied from the power supply to the motor.

### SUMMARY OF THE INVENTION

The present disclosure provides, in one aspect, a power supply configured to supply electrical power to a connected power tool having a motor and an identifier representative of a characteristic of the connected power tool. The power supply including a housing including a battery receptacle configured to receive a battery pack, a strap coupled to the housing, and an electronic control unit positioned within the housing. The electronic control unit configured to interface with the identifier to determine the characteristic of the connected power tool and, in response to the determined characteristic, supply electrical power from the battery pack to the motor at an associated power output.

The present disclosure provides, in another aspect, a power tool assembly including a power tool having a motor coupled to a working element and an identifier representative of a characteristic of the power tool. The power tool assembly further including a housing having a battery receptacle configured to receive a battery pack, a strap coupled to the housing, and an electronic control unit positioned within the housing. The power tool assembly further includes an electrical cord connecting the power supply to the power tool. The electronic control unit configured to interface with the identifier to determine the characteristic of the connected power tool and, in response to the determined characteristic, supply electrical power from the battery pack to the motor at an associated power output. The power tool assembly further includes an electrical cord connecting the power supply to the power tool, the electrical cord configured to transmit the electrical power from the power supply to the motor.

The present disclosure provides, in another aspect, a method of operating a pump including an identifier representative of a characteristic of the pump. The method includes electrically connecting the pump with a portable power supply including a battery pack. Electrical power is supplied, with an electronic control unit of the portable power supply, from the battery pack to the pump. The electronic control unit determines the characteristic by interfacing with the identifier onboard the pump. The electronic control unit computes a shutoff threshold based on the identifier. The electronic control unit determines that the shutoff threshold is crossed. In response to the shutoff threshold being crossed, the supply of electrical power from the power supply to the pump is discontinued.

The present disclosure provides, in another aspect, a method of operating a pump including an identifier representative of an input parameter of the pump. The method includes electrically connecting the pump with a portable power supply including a battery pack. Electrical power is supplied, with an electronic control unit of the portable power supply, from the battery pack to the pump. The electronic control unit determines the numerical value by interfacing with the identifier onboard the pump. The electronic control unit computes a shutoff threshold based on the numerical value. The electronic control unit determines that the shutoff threshold is crossed; and in response to the shutoff threshold being crossed, discontinues the supply of electrical power from the power supply to the pump.

Other features and aspects of the invention will become apparent by consideration of the following detailed description and accompanying drawings.

### BRIEF DESCRIPTION OF THE DRAWINGS

FIG. 1 is a perspective view of a power tool assembly including a portable power supply configured to be coupled to any one of a plurality of power tools.

FIG. 2 is a schematic view of the power tool assembly of FIG. 1 where the portable power supply and the power tool are coupled by a cord.

FIG. 3 is a schematic view of the power tool assembly of FIG. 1 where the portable power supply and the power tool are coupled by wireless connection.

FIG. 4 is a schematic view of the power tool assembly of FIG. 1 where the portable power supply and the power tool are coupled by wireless connection and are further coupled by wireless connection to an external device.

FIG. 5 is a flowchart depicting a tool identification method for use with the power tool assembly of FIG. 1.

FIG. 6 is a cross-sectional view of an exemplary power tool in the form of a submersible pump.

FIG. 7 is a cross-sectional view of an exemplary power tool in the form of a concrete vibrator head.

FIG. 8 is a graph illustrating operating curves of a first submersible pump and a second submersible pump.

FIG. 9 is an elevation view of the power tool assembly where the submersible pump of FIG. 6 transfers fluid from a hole to ground level.

FIG. 10 is an elevation view of the power tool assembly where the submersible pump of FIG. 6 operates in a dry pumping operation.

FIG. 11 is a flowchart depicting an auto-shutoff method for use with the power tool assembly of FIG. 1.

FIG. 12 is a graph illustrating operating and shutoff threshold curves of a first submersible pump and a second submersible pump.

FIG. 13 is a flowchart depicting another tool identification method for use with the power tool assembly of FIG. 1.

FIG. 14 is a flowchart depicting another auto-shutoff method for use with the power tool assembly of FIG. 1.

FIG. 15 is a graph illustrating shutoff threshold curves and exemplary second order polynomial coefficients thereof for the first submersible pump and the second submersible pump.

FIG. 16 is a graph illustrating shutoff threshold curves and exemplary exponential coefficients thereof for the first submersible pump and the second submersible pump.

FIG. 17 is a cross-sectional view of another exemplary power tool in the form of a trash pump.

FIG. 18 is another cross-sectional view of the trash pump of FIG. 17.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

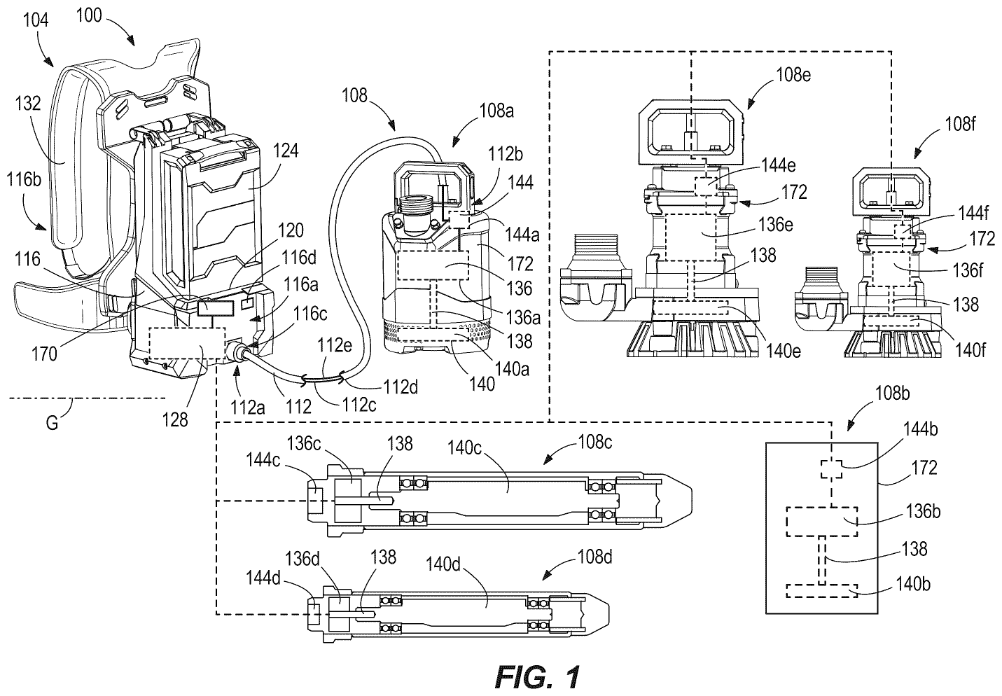

FIG. 1 illustrates a power tool assembly 100 including a portable power supply 104 coupled to a power tool 108 by a cord 112. The cord 112 may be flexible. The portable power supply 104 includes a housing 116 defining a first (i.e., rearwardly facing) side 116a, a second (i.e., forwardly facing) side 116b, an interior 116c, and a control panel 116d on the first side 116a. A battery receptacle 120 configured to removably receive (i.e., engage) a battery pack 124 is located on the housing 116. In the illustrated embodiment, the battery receptacle 120 is located on the first side 116a. An electronic control unit 128 is positioned within the interior 116c. The electronic control unit 128 is configured to control a supply of electrical power (i.e., electrical current) from the battery pack 124 through the cord 112 to the power tool 108. The power tool 108 and the cord 112 are removably couplable from the portable power supply 104. The electronic control unit 128 can determine which type of power tool 108 is coupled to the portable power supply 104 based on an identifier 144 of the connected power tool 108. For example, the electronic control unit 128 can determine whether a submersible pump 108a, 108b, a concrete vibrator head 108c, 108d, or a trash pump 108e is connected to the portable power supply 104. The electronic control unit 128 is configured to supply a varying power output from the battery pack 124 to the power tool 108 depending on requirements of the connected power tool 108. As such, different types of power tools 108 with different power requirements (e.g., a large pump 108a, a large concrete vibrator head 108c, a large trash pump 108e), and different power tools 108 of the same type with different power requirements (e.g., a large pump 108a, a small pump 108b, small trash pump 108f) can be powered by the same portable power supply 104.

Backpack straps 132 are coupled to the second (i.e., forwardly facing) side 116a of the housing 116. The backpack straps 132 allow a user to maneuver the portable power supply 104 from worksite to worksite sequentially between uses of the power tool 108. Additionally, the backpack straps 132 allow the portable power supply 104 to be worn by the user as the power tool 108 is operated.

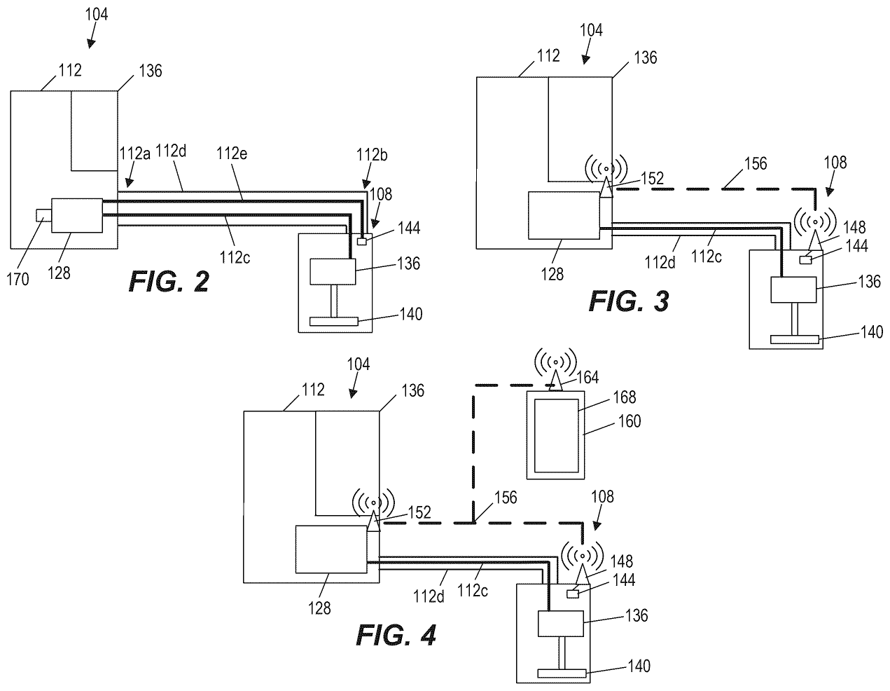

As illustrated in FIG. 2, the cord 112 includes a power unit end 112a coupled to the portable power supply 104 and an opposite power tool end 112b coupled to the power tool 108. The illustrated cord 112 includes at least a conductive power supply wire 112c capable of transmitting electrical current from the power unit end 112a (from the battery pack 124 mounted on the portable power supply 104) to the power tool end 112b to drive an electric motor 136 of the power tool 108. The motor 136 is coupled to a working element 140 by a rotor shaft 138. The cord 112 may further include an electrically insulative outer sheath 112d. The cord 112 may further include one or more signal wires 112e. The signal wires 112e may be positioned within the sheath 112d. As illustrated in FIG. 1, the cord 112 may couple any one of the power tools 108a-108d to the portable power supply 104.

The power tool 108 includes the identifier 144, which is indicative of a characteristic of the power tool 108. The characteristic may be indicative of, for example, one or more physical characteristics (e.g., diameter, height, impeller geometry, size, working element geometry, motor type (e.g., 4 pole, 6 pole, inner rotor, outer rotor, etc.), etc.) and/or one or more operational characteristics (e.g., power rating, flow rate, head height, motor operating speed, motor power level, etc.) of the power tool 108. The characteristic may be representative of power input requirements of the power tool (e.g., an amount of power required to operate the motor 136 of the power tool 108). The characteristic may be indicative of or representative of a range of operating power required to operate the power tool 108 or for desired operation of the power tool 108. The characteristic may be representative of a control scheme (e.g., open loop control, closed loop speed control, closed loop power control, etc.) of the power tool 108.

The identifier 144 may be a resistor. In such an embodiment, the electronic control unit 128 may supply detection current at a first voltage through the one or more signal wires 112e to the identifier (i.e., resistor, integrated circuit) 144. After passing through the resistor, a second amount of voltage is returned to the electronic control unit 128 via the one or more signal wires 112e. The electronic control unit 128 may calculate a voltage drop between the first voltage and the second voltage, the voltage drop being indicative of a resistance value of the resistor (e.g., in Ohms, R2). The electronic control unit 128 may compare the resistance of the connected identifier 144 to a stored and known resistance value (e.g., in Ohms, R1) associated with the characteristic of a baseline power tool 108 (e.g., the large pump 108a). The electronic control unit 128 can then calculate a scaling value (K) by comparing the resistance value of the connected power tool 108 (R2) with the resistance value (R1) of a baseline power tool (e.g., K=R2/R1, which is a unitless value). The scaling value K can be applied as a multiple or other input to adjust operating parameters of the baseline power tool (e.g., large pump 108a) to be scaled up or down to the connected power tool (e.g., small pump 108b).

For example, a resistance value R1 of a baseline large pump 108a may be 100 Ohms, and information relating to the resistance of the baseline large pump 108a is stored in a memory of the electronic control unit 128. When the cord 112 is disconnected from the large pump 108a and reconnected to a small pump 108b, the one or more signal wires 112e are coupled to the identifier (i.e., resistor) 144 of the small pump 108b. Based on the voltage drop of the signal wires 112e, the electronic control unit 128 may compute a resistance value R2 of the small pump 108b may be 50 Ohms. In this example, the scaling value K is 0.5. The electronic control unit 128 may then utilize the scaling value K to send half as much electrical power to the small pump 108b in comparison with the large pump 108a.

In other embodiments, the identifier 144 may be an integrated circuit or any other identifying structure mounted on the power tool 108. In such an embodiment, the electronic control unit 128 may otherwise be coupled to (e.g., mechanically, electrically, fluidly, etc.) to the identifier 144, and the control unit 128 may send an identification request to the identifier 144. The identifier 144 may send a return indication of the characteristic of the connected power tool 108. Based on the return identification, the electronic control unit 128 may then identify at least one of the characteristics, the type of power tool connected, and the power requirements of the connected power tool 108, and then supply the connected power tool 108 with an associated power output appropriate for the connected power tool. For example, the power supply 104 may provide higher power output for connected power tools (e.g., large pump 108a, large concrete vibrator head 108c) requiring high power inputs, and the power supply 104 may provide lower power output for connected power tools (e.g., small pump 108b, small concrete vibrator head 108d) requiring lower power inputs.

In the embodiment illustrated in FIGS. 1 and 2, the cord 112 connects the portable power supply 104 to a large pump 108a. One or more signal wires 112e electrically couple the electronic control unit 128 with the identifier 144. The signal wires 112e are illustrated as within the same sheath 112d as the power supply wire 112c. The signal wires 112e may be located outside of the sheath 112d and/or include their own electrically insulative sheath. The cord 112 may be disconnected from the large pump 108a, and connected with any of a small pump 108b, a large concrete vibrator head 108c, and a small concrete vibrator head 108d.

In FIG. 3, the power tool 108 includes a first wireless communication device 148, the portable power supply 104 includes a second wireless communication device 152, and data regarding the identifier 144 of the power tool 108 is communicated from the power tool 108 to the electronic control unit 128 by a wireless signal 156 (e.g., via Bluetooth connection, WI-FI, or cellular data). The wireless signal 156 can include data indicative of or stored by the identifier 144. The data may be representative of the characteristic of the power tool 108. The electronic control unit 128 can determine, based on the data, which power tool (e.g., 108a-108d) is connected, and to scale up or down the power output supplied by the power supply from the battery pack 124 via the power supply wire 112c to the motor 136 of the connected power tool 108.

With reference to FIG. 4, an external device 160 with a third wireless communication device 164 in communication with both the first wireless communication device 148 and the second wireless communication device 152 is shown. The external device 160 may be, for example, a cellular phone, tablet, electronic remote, or the like. The third wireless communication device 164 may receive the wireless signal 156 from the first wireless communication device 148 on the power tool 108. The external device 160 may further include a screen 168 to display thereon data relating to the identifier 144 of the connected power tool 108. The screen 168 may be a pixelated screen. Alternatively, any other means (e.g., auditory, tactile vibration, etc.) may provide an indication to a user of the external device 160 data relating to the identifier 144. The third wireless communication device 164 may be configured to receive data regarding the identifier and to provide data regarding the identifier (i.e., to relay data) via the wireless signal 156 to the second wireless communication device 152 on the electronic control unit 128. The electronic control unit 128 can then be configured to supply the power tool 108 with an appropriate power output. The external device 160 may receive data regarding operation of the power tool 108, and may notify the user of a change in operation of the power tool 108. For example, the external device 160 may display whether or not the power tool 108 is activated For example, the external device 160 may display on the screen 168 an indicator for indicating whether the large pump 108a is ON or has been turned OFF (e.g., by the auto-shutoff method 500 described in detail below).

With reference to FIGS. 1 and 2, the portable power supply 104 may include a screen 170 to display thereon data relating to the identifier 144 of the connected power tool 108. The screen 170 may be a pixelated screen. The screen 170 may receive one or more signals indicative of data to be displayed and relating to characteristics of the connected power tool 108 from the electronic control unit 128. Alternatively, any other means (e.g., auditory, tactile, vibration, etc.) may provide an indication to a user of the portable power supply 104 data regarding the identifier 144. The screen 170 may optionally be implemented in either of the embodiments of FIG. 3 or 4 including wireless communication devices 148, 152.

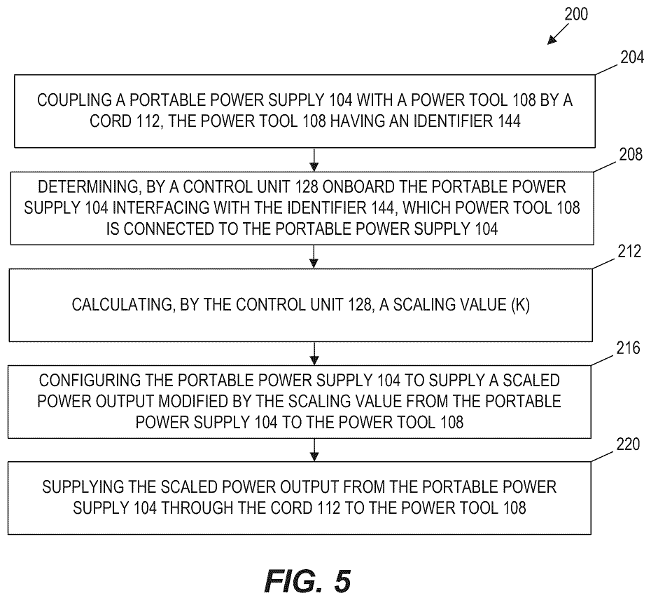

In some embodiments, the action of connecting the cord 112 to both the portable power supply 104 and the power tool 108 may initiate a tool identification scheme (i.e., method) 200 as illustrated in FIG. 5. Additionally or alternatively, the tool identification scheme 200 may be initiated at any time during operation of the power tool assembly 100. For example, the tool identification scheme 200 may be periodically initiated and conducted to ensure the same power tool 108 is connected to the portable power supply 104.

At step 204 in the tool identification scheme 200 (FIG. 5), the portable power supply 104 is coupled with a power tool 108 by the cord 112. At step 208, the electronic control unit 128 determines which power tool 108 (e.g., large pump 108a, small pump 108b, large concrete vibrator head 108c, small concrete vibrator head 108d) is connected by utilizing the identifier 144 as described above. In sum, the control unit 128 interfaces with the identifier 144 to determine which power tool 108 is connected to the portable power supply 104. Optionally after step 208, a characteristic of the connected power tool 108 may be displayed on either of both of the screens 168, 170. At step 212, the electronic control unit 128 calculates a scaling value (K). At step 216, the electronic control unit 128 configures the portable power supply 104 to supply a scaled power output from the portable power supply 104 to the connected power tool 108 as modified by the scaling value (K). At step 220, the scaled power output is supplied from the portable power supply 104 through the cord 112 (e.g., the power supply wire 112c) to the power tool 108. The supply of power provided at step 220 may be initiated by, for example, user actuation of the control panel 116d when the power tool assembly 100 is in place and ready for use.

The tool identification scheme 200 is advantageous because it allows the electronic control unit 128 to scale power output provided to the connected power tool 108 without requiring additional user input (e.g., without requiring the user to otherwise input the type of power tool at the control panel 116d), without requiring modification or updates to the electronic control unit 128, and without requiring prior connection between the power tool 108 and to the portable power supply 104. The described options for providing the identifier 144 (e.g., resistor, integrated circuit, wireless communication module, etc.) are cost effective, and can easily be implemented on future power tools 108 not yet developed and having power requirements which need to be scaled from existing portion tools 108. The electronic control unit 128 is configured to supply a scaled power output from the battery pack 124 to the motor 136 based on the identifier 144 of any connected power tool (e.g., future power tools 108) having the identifier 144 and without requiring prior connection between the power tool 108 and the electronic control unit 128 or modification of the electronic control unit 128 itself.

Any type of power tool may be connected and powered by the portable power supply 104. Pumps 108a, 108b (i.e., submersible pumps), concrete vibrator heads 108c, 108d, and trash pumps 108e, 108f merely provide examples of different types of power tools. The pumps 108a, 108b, 108e, 108f and concrete vibrator heads 108c, 108d may require differing (i.e., a first, second, third, fourth) power inputs for operation. Operating ranges of the pumps 108a, 108b, 108e, 108f and concrete vibrator heads 108c, 108d and/or other power tools 108 capable of being connected to the portable power supply 104 may overlap. In some embodiments, the same cord 112 may be used for each of the power tools 108a-108f. Alternatively, different cords 112 capable of transmitting higher or lower levels of electrical current may be used for different power tools 108a-108f or subsets of power tools 108 in accordance with power requirements thereof. Each power tool 108 includes the motor 136, working element 140, and identifier 144 with a corresponding alphanumeric reference numeral (e.g., 136a, 140a, 144a).

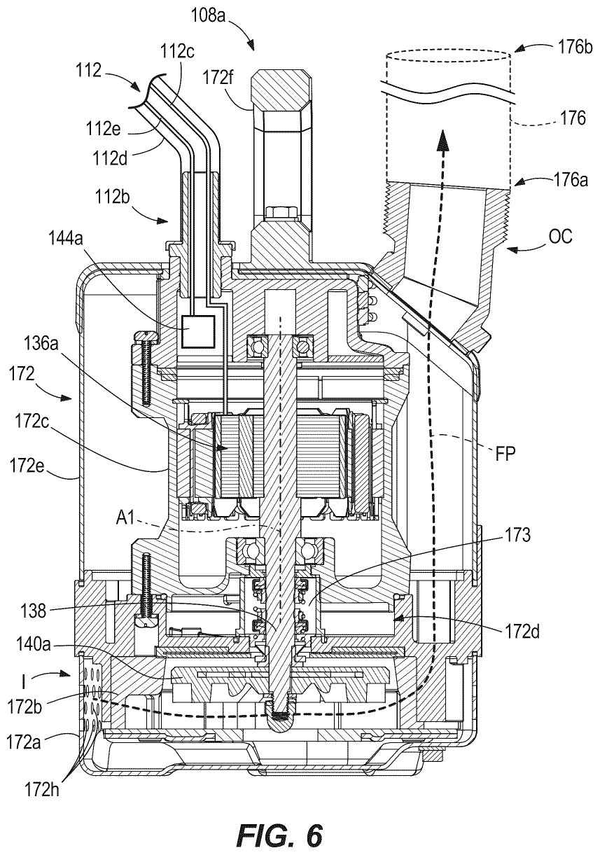

As illustrated in FIG. 6, the working element 140 of the pump 108a is an impeller 140a. The size and capacity of the motor 136a of the pump 108a may generally correspond with the size and capacity of the impeller 140a.

The pump 108a further includes a housing 172 with an inlet I, an outlet connector OC, an inlet strainer 172a, an impeller shroud 172b (i.e., volute), a motor sub-housing 172c, an oil lifter sub-housing 172d, an outer housing 172e, and a handle 172f. The inlet I is configured to receive working fluid from a hole H driven by the impeller 140a. The inlet strainer 172a is positioned at the inlet I and includes a plurality of holes 172h capable of permitting the working fluid to enter the housing 172 and inhibiting at least some solid debris (e.g., leaves, dirt, rocks) carried by the working fluid from entering the housing 172, and more specifically, the impeller shroud 172b. The holes 172h extend through the inlet strainer 172a to permit fluid communication between the inlet I and the impeller shroud 172b. The holes 172h are positioned radially outboard the impeller 140a with respect to the axis A1. In other words, the inlet I is located at the same height as the impeller 140a (e.g., as viewed in FIG. 6). The illustrated holes 172h are circular in shape and are spaced from one another in a pattern about the axis A1. Other hole arrangements are possible. The impeller 140a is positioned within the impeller shroud 172b. During typical operation of the pump 108a, the working fluid may have a relatively low (e.g., less than 50%) concentration of solid debris passable through the inlet strainer 172a and into the housing 172.

The motor sub-housing 172c encloses at least a portion of the motor 136a therein. The identifier 144a and/or other components may also be enclosed by the motor sub-housing 172c. The motor sub-housing 172c includes connections facilitating engagement of the cord 112 to the portable power supply 104 and of the rotor shaft 138 with the impeller 140a outside of the motor sub-housing 172c and exposed to the inlet I.

The impeller shroud 172b is sealed from the motor sub-housing 172c by an oil lifter 173 within the oil lifter sub-housing 172d. The oil lifter 173 may circulate coolant within the oil lifter sub-housing 172d to pass heat generated by the motor 136 and/or bearings supporting the rotor shaft 138 to the coolant and ultimately to the working fluid, for example, within the impeller shroud 172b.

Working fluid driven by the impeller 140a passes along a fluid flow path FP from the inlet I and along the impeller shroud 172b to an interior of the housing 172 between the motor sub-housing 172c and the outer housing 172e. The fluid may then take an annular shape between the motor sub-housing 172c and the outer housing 172e about the axis A1, and circumscribe the motor sub-housing 172c therein as it passes toward and out the outlet connector OC. The illustrated outlet connector OC removably coupled to the outer housing 172e. However, in other embodiments, the outlet connector OC may be otherwise coupled (i.e., integrally formed) with the outer housing 172e. The outlet connector OC can be coupled to a tube 176 having a pump end 176a connectable to the outlet connector OC and an output end 176b capable of being positioned near a desired outlet point of the working fluid driven by the impeller 140a.

The illustrated outlet connector OC is dimensioned to direct an end of the tube 176 connected thereto is oriented in a direction parallel to the axis A1. In other arrangements or embodiments, the outlet connector OC may be reoriented relative to the housing 172 or otherwise replaced with a different outlet connector OC such that the end of the tube 176 connected to the outlet connector OC is oriented in a different direction such as a direction transverse to or perpendicular to the axis A1. The tube 176 may be flexible. In the illustrated embodiment, upon activation of the motor 136a, the working element 140a is rotated about axis A1, and working fluid from hole H is driven along flow path FP from the inlet I and into the tube 176. The handle 172f is located axially adjacent the outlet connector OC, and permits the pump 108a to be hand carried by a user U. A length of the tube 176 between the pump end 176a and the output end 176b may be selected depending on the desired distance of flow of the fluid moved by the pump 108a. The tube 176 may have a length greater than a maximum head of the pump 108a (i.e., the highest the pump 108a can transfer fluid).

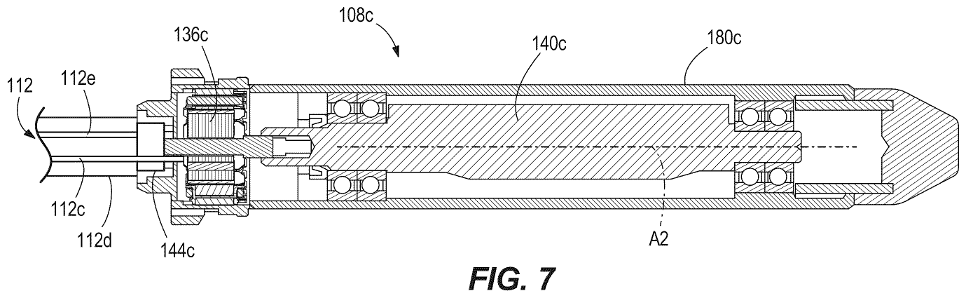

With reference to FIGS. 1 and 7, the concrete vibrator head 108c includes a housing 180c and the working element 140c thereof is an eccentric mass 140c positioned within a housing 180c. A motor 136c of the concrete vibrator head 108c is configured by be driven about a rotational axis A2 to cause the eccentric mass 140c to rotate with its center of mass offset from the rotational axis A2, thereby inducing vibration in the housing 180c (e.g., causing the housing 180c to vibrate). The concrete vibrator head 108c has an identifier 144 connectable to the control unit 128 via the signal wires 112e.

The large pump 108a may pump fluid (e.g., water) with little to no solids therein and have physical dimensions and operating characteristics in accordance with those listed below. The inlet I and inlet strainer 172a may permit debris of less than approximately 0.25 inches (approximately 6.35 millimeters) in diameter to pass therethrough and into the working fluid entering the housing 172. The large pump 108a may be operable in a range of between 2000 rpm and 3500 rpm; however other pumps may differ in their operating speed ranges. The large pump 108a may include a motor 136a rated for 1 horsepower (i.e., 745.7 watts). The large pump 108a may be operable to pass a flow rate of above 50 gallons per minute (gpm, approximately 190 liters per minute, lpm), optionally above 60 gpm (approximately 230 lpm), optionally above 70 gpm (approximately 260 lpm), and optionally above 80 gpm (approximately 300 lpm). The large pump 108a may have a maximum flow rate of between 80 gpm and 100 gpm (between approximately 300 lpm and approximately 380 lpm). In the illustrated embodiment, the large pump 108a has a maximum flow rate of 82 gpm (approximately 310 lpm). The large pump 108a may include a 2 inch (5.08 centimeter) diameter outlet connector OC and tube 176. The cord 112 may have a length of 35 feet (approximately 11 meters). The large pump 108a may have a max head height of greater than 50 feet (approximately 15 meters) and less than 75 feet (approximately 23 meters). The large pump 108a has a max head height of 59 feet (approximately 18 meters). The exemplary large pump 108a has physical length, width, and height respectively of 189 millimeters, 189 millimeters, and 341 millimeters; and a weight of 28 pounds (approximately 12.7 kilograms). The large pump 108a may have an outlet connector OC and tube 176 each with an inner diameter of approximately 2 inches (approximately 5 centimeters). Sizing and operating parameters of the large pump 108a may be adjusted to meet demand and use case of the power tool assembly 100. Alternatively, the small pump 108b or either trash pump 108e, 108f may be connected to the portable power supply 104 to meet demand and use case of the power tool assembly 100.

Components of the large pump 108a and large concrete vibrator head 108c may be sized differently in the small pump 108b and small concrete vibrator head 108d but function in similar manners. Physical dimensions and/or operating characteristics of the small pump 108b may differ from those listed above regarding the large pump 108a. Components of the small pump 108b and small concrete vibrator head 108d are identified with corresponding alphanumeric reference numerals.

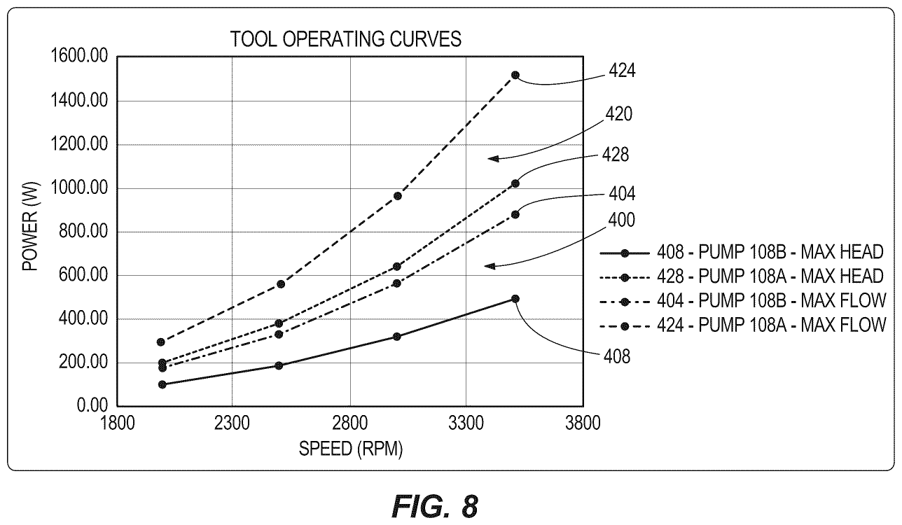

With reference to FIG. 8, the small pump 108b is operable within a first operating range 400 defined between the power output-speed curves 404, 408 of the motor 136b. More specifically, the first operating range 400 extends between a first maximum flow curve 404 and first maximum head curve 408.

The first maximum flow curve 404 represents an operating condition of the portable power supply 104 and small pump 108b whereby at given speed (rpm, e.g., 3000 rpm) of the motor 136b, head height lifted by the small pump 108b (e.g., gravitational potential energy) is minimal (e.g., zero), and nearly all (if not all) work done by the motor 136b and impeller 140b to the working fluid provides kinetic potential energy to the working fluid (due to movement of the working fluid as imparted by the impeller 140b). When operating at the given speed (e.g., 3000 rpm), the motor 136b draws a corresponding power input (e.g., approximately 550 Watts) from the battery pack 124. Operating conditions of the power tool assembly 100 may differ during use. For example, if the small pump 108b is first operated with solely the outlet connector OC, power required by the motor 136b and supplied by the portable power supply 104 may closely reflect the maximum flow curve 404. Once the pump end 176a of a tube 176 is coupled to the outlet connector OC, and the output end 176b of the tube 176 is raised from the outlet connector OC, less power (e.g., less than the approximately 550 Watts) is required by the motor 136b while operating the motor 136b at the same motor speed (e.g., 3000 rpm).

The first maximum head curve 408 represents an operating condition of the portable power supply 104 and small pump 108b whereby at the given speed (rpm, e.g., 3000 rpm) of the motor 136b, nearly all (if not all) work done by the motor 136b and the impeller 140b to the working fluid is converted to gravitational potential energy of the working fluid. When operating in the max head operating condition (e.g., with tube 176 pointing upward from the small pump 108b) at the given speed (e.g., 3000 rpm), the motor 136b draws a corresponding power input (e.g., approximately 300 Watts) from the battery pack 124 to drive the motor 136b and impeller 140b to provide max head gain of the working fluid.

Power required by the motor 136b and supplied by the portable power supply 104 may vary depending on various factors. For example, as illustrated in FIG. 8, power required by the motor 136b generally exponentially increases with an increase in speed of the motor 136b. This exponential increase is common for pumps such as the small pump 108b and the large pump 108a. Other similar phenomena may be observed for power tools 108 other than pumps.

With continued reference to FIG. 8, like the small pump 108b, the large pump 108a is operable within a second operating range 420. In the illustrated embodiment, the second operating range 420 does not overlap the first operating range 400. The second operating range 420 extends between a second maximum flow curve 424 and a second maximum head curve 428.

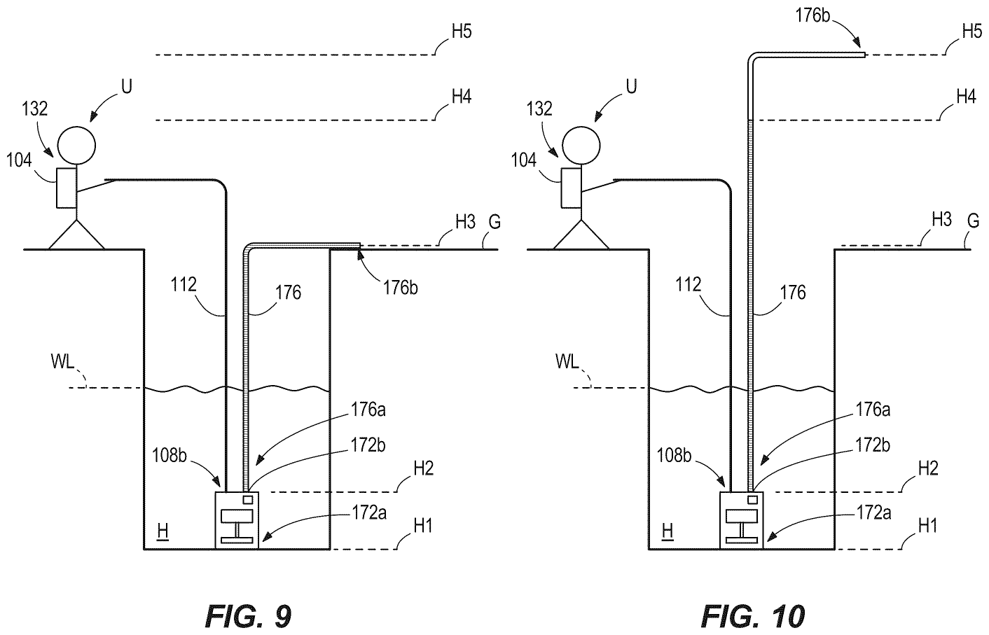

FIG. 9 illustrates the use of the small pump 108b within a hole H and within the first operating range 400. As illustrated in FIG. 9, a user U may wear, hold, or otherwise support the backpack straps 132 to carry the portable power supply 104 during operation of the small pump 108b. Alternately, the portable power supply 104 may be supported by the ground G. The small pump 108b illustrated in FIG. 9 as submersed below the water level WL of fluid within the hole H. The small pump 108b is coupled to the portable power supply 104 via the cord 112. The inlet I of the small pump 108b may be positioned at a hole level HI at the bottom of the hole H. The outlet connector OC of the small pump 108b may be positioned at a pump level H2 which may be above or below the water level WL during operation of the small pump 108b. In other words, the small pump 108b may be fully submersed below the water level WL or partially submersed below the water level WL during use. In other embodiments and/or use cases of the small pump 108b, the water level WL may be between the hole level H1 and the pump level H2. The output end 176b of the tube 176 is positioned at a first output level H3 below a max head level H4 (represented by max head curve 408) of the small pump 108b. Since the output end 176b is below the max head level H4, the small pump 108b can provide sufficient power to the working fluid (when operated at the given speed) to transfer the working fluid to the first output level H3. Thus, FIG. 9 shows a wet pumping operation of the power tool assembly 100 whereby the small pump 108b is powered by the portable power supply 104 and the portable power supply 104 outlets fluid from the output end 176b of the tube 176. FIG. 8 illustrates the power tool assembly 100 whereby the small pump 108b is operated within its first operating range 400. Similar operation is possible at various (i.e., variable) speeds as depicted in FIG. 8. Similar operation is possible with the large pump 108a.

In contrast to the wet pumping operation of FIG. 9 (whereby working fluid is transferred by the small pump 108b out the output end 176b of the tube 176), FIG. 10 illustrates a dry pumping operation whereby working fluid is acted upon by the small pump 108b, but no working fluid is transferred from the output end 176b of the tube 176 by the small pump 108b. In the dry pumping operation, the output end 176b of the tube 176 is positioned at a second output level H3 above the max head level H4 (represented by max head curve 408) of the small pump 108b. Since the output end 176b is above the max head level H4, the small pump 108b cannot provide sufficient power to the working fluid (when operated at the given speed) to pump the working fluid to the second output level H5. During the dry pumping operation, power is supplied from the portable power supply 104 to operate the motor 136b, and the impeller 140b drives working fluid from the inlet I into the tube 176, but the kinetic potential energy of the working fluid (generated by movement of the impeller 140b, derived by speed of moving working fluid) is converted to gravitational potential energy (derived by height of working fluid) before the fluid reaches the output end 176b. The working fluid remains trapped in the tube 176, and bubbles at the max head level H4, which represents an intermediate height between the pump end 176a and the output end 176b of the tube 176. In the dry pumping operation, since no working fluid exits the output end 176b, the motor 136b is operated unnecessarily, and chemical potential energy stored by the battery pack 124 is wasted, thus unnecessarily decreasing life and runtime of the battery pack 124.

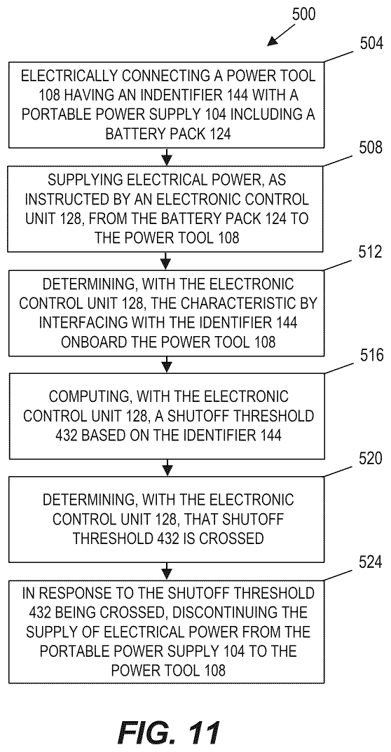

The power tool assembly 100 may utilize the identifiers 144a, 144b of the pumps 108a, 108b to avoid such dry pumping operations. FIG. 11 illustrates an auto-shutoff method 500 of the power tool assembly 100. The auto-shutoff method (i.e., scheme) 500 includes a step 504 whereby a power tool 108 (e.g., the small pump 108b) is electrically connected to the portable power supply 104 via the cord 112. In step 508, electrical power is supplied, as instructed by the electronic control unit 128 to the power tool 108 (e.g., the small pump 108b). In step 512, the electronic control unit 128 determines the characteristic of the power tool 108 (e.g., the size of the impeller of the connected small pump 108b) by interfacing with the identifier 144 (e.g., the identifier 144b) of the power tool 108 (e.g., the small pump 108b). In step 516, the electronic control unit 128 computes a shutoff threshold curve 432 based on the identifier 144. The shutoff threshold curve 432 may be the same as or different than a baseline shutoff threshold (e.g., a baseline shutoff threshold curve). The shutoff threshold curve 432 may be computed by multiplying the scaling value K with the baseline shutoff threshold curve. Such a baseline shutoff threshold curve may be saved or in other words hard coded into memory onboard the electronic control unit 128. In step 520, the electronic control unit 128 determines that, while operating the motor 136 (e.g., 136b) at the set speed (e.g., 3000 rpm), the power output to the motor 136 (e.g., motor 136b) by the power supply 104 crosses the shutoff threshold curve 432. In response to the shutoff threshold 432 being crossed, at step 524, the electronic control unit 128 discontinues (i.e., inhibits, stops) the supply of electrical power from the portable power supply 104 to the power tool 108 (e.g., small pump 108b).

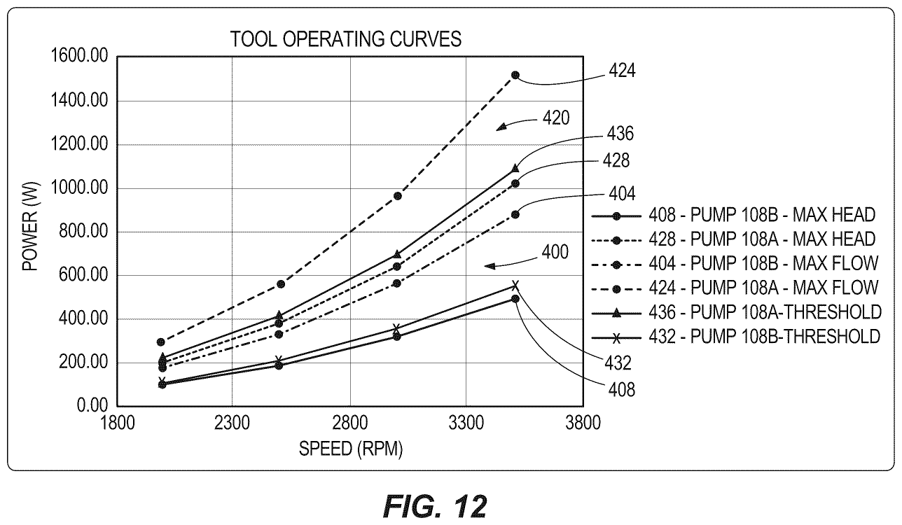

For example, the shutoff threshold curve 432 may represent the baseline shutoff threshold curve, where the small pump 108b provides a baseline value (e.g., resistance R2 of 50 Ohms provided by identifier 144b). When the small pump 108b is disconnected, and the large pump 108a is connected, the scaling value K is calculated by comparing a value indicated by the identifier 144a (e.g., resistance R1 of 100 Ohms, K=2), and the second shutoff threshold curve 436 is calculated by multiplying the shutoff threshold curve 432 and the scaling value K. In the illustrated embodiment, the scaling value K is applied equally along the various motor speeds (rpm, x axis of FIG. 12). In other embodiments, the scaling value K may differ at various motor speeds (rpm, x axis of FIG. 12).

As illustrated in FIG. 12, a first shutoff threshold curve 432 is calculated for the small pump 108b when the small pump 108b is coupled to the portable power supply 104. The first shutoff threshold curve 432 is calculated based on the identifier 144b. A second shutoff threshold curve 436 is calculated for the large pump 108a when the large pump 108a is coupled to the portable power supply 104. The second shutoff threshold curve 436 is calculated based on the identifier 144a. The first shutoff threshold curve 432 and the second shutoff threshold curve 436 are computed such that they are slightly above (as viewed in FIG. 12) the corresponding maximum head curve 408, 428. As such, when the tube 176 is raised above the max head level H4 with the motor 136 at the same speed, the corresponding shutoff threshold curve 432, 436 is crossed and the auto-shutoff method 500 is initiated prior or soon after the dry pumping operating condition occurring.

The same auto-shutoff method 500 is capable of stopping the supply of power from the portable power supply 104 to any connected power tool 108. For example, the small pump 108b may be decoupled from the cord 112, and the large pump 108a may be coupled to the cord 112. While the described auto-shutoff method 500 is optimized to avoid dry pumping, the auto-shutoff method 500 may be adapted for other types of power tools 108 such as, and without limitation, concrete vibrator heads 108c, 108d, for ensuring adequate consolidation of wet concrete.

While the above-described scaling value (K) operable to calculate the shutoff threshold curve 432 by multiplying with the baseline shutoff threshold curve, for different-shaped pump operating curves, rather than applying a scaling value (K) as a multiple to a baseline (i.e., hard coded) shutoff threshold curve, it may be beneficial to calculate an entirely new shutoff threshold curve for each connected tool 108.

In some embodiments, the identifier 144 (e.g., integrated circuit) may be configured to transmit one or more (e.g., two, three, etc.) input parameters from the tool 108 to the electronic control unit 128 to compute an operating shutoff threshold curve 432, 436 for each connected tool (e.g., pumps 108a, 108b). The input parameters may be one or more coefficients (A, B, C, D, E) or variables in a mathematical equation. Any of the one or more input parameters may be utilized to determine the characteristic (e.g., the size of the impeller of the connected small pump 108b, etc.) of the connected power tool and, in response to the determined characteristic, supply electrical power from the battery pack 124 to the motor 136 of the tool 108 at an associated power output.

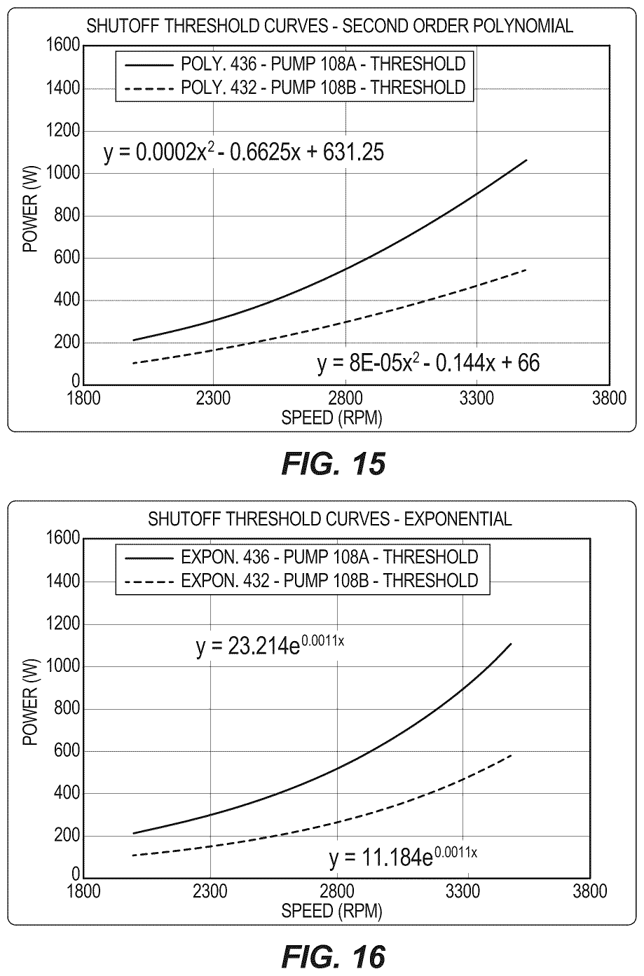

The mathematical equation may be a polynomial equation. For example, the mathematical equation may be a second order polynomial with three coefficients (A, B, C; shutoff threshold curve =Ax\hat{ }2+Bx+C), in other words, a quadratic polynomial. Various mathematical equations may be utilized, and the input parameters need not be coefficients. For example, an exponential mathematical equation may be utilized (shutoff threshold curve=D*e\hat{ }(E*x)). Exemplary threshold curve equations and coefficients are discussed below regarding FIGS. 15 and 16. Different pumps 108A, 108B may have different identifiers 144 (e.g., different integrated circuits) that provide different input parameters (e.g., coefficients, A, B, C) to the control unit 128 for calculating the shutoff threshold curve 432. In some instances, identifiers 144 of different connected tools 108 may provide one or more input parameters that are the same.

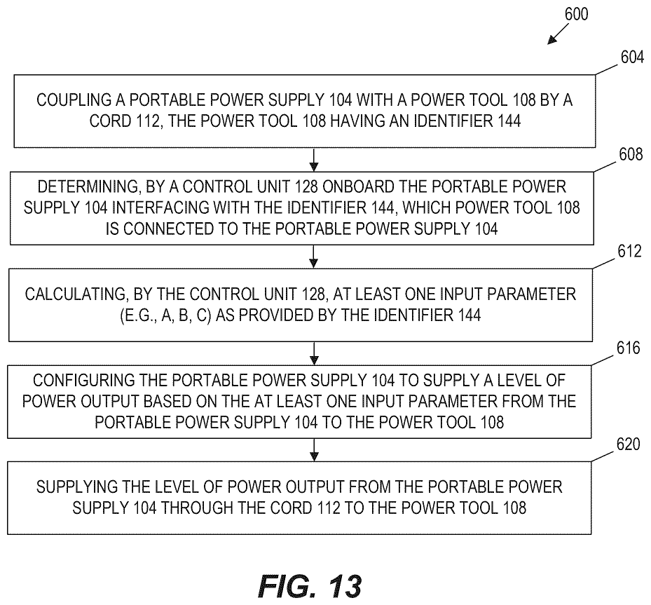

Similarly to the tool identification scheme (i.e., method) 200 as illustrated in FIG. 5, the action of connecting the cord 112 to both the portable power supply 104 and the power tool 108 may initiate a tool identification scheme (i.e., method) 600 as illustrated in FIG. 13. The tool identification scheme 600 may be periodically initiated and conducted to ensure the same power tool 108 is connected to the portable power supply 104.

At step 604 in the tool identification scheme 600 (FIG. 13), the portable power supply 104 is coupled with a power tool 108 by the cord 112. At step 608, the electronic control unit 128 determines which power tool 108 (e.g., large pump 108a, small pump 108b, large concrete vibrator head 108c, small concrete vibrator head 108d) is connected by utilizing the identifier 144 as described above. The determination may be based on one or more of the input parameters (A, B, C) provided by the identifier 144 and/or a distinct tool identifier. In sum, the control unit 128 interfaces with the identifier 144 to determine which power tool 108 is connected to the portable power supply 104. At step 612, the electronic control unit 128 calculates at least one input parameter (A, B, C) based on the connected identifier 144. For example, the electronic control unit 128 may calculate entirely different input parameter coefficients to calculate the operating shutoff threshold curves 432, 436 of the large pump 108A and the small pump 108B. At step 616, the electronic control unit 128 configures the portable power supply 104 to supply an appropriate level of power output from the portable power supply 104 to the connected power tool 108 as indicated by at least one of the input parameters (A, B, C). At step 620, the scaled power output is supplied from the portable power supply 104 through the cord 112 (e.g., the power supply wire 112c) to the power tool 108. The supply of power provided at step 620 may be initiated by, for example, user actuation of the control panel 116d when the power tool assembly 100 is in place and ready for use.

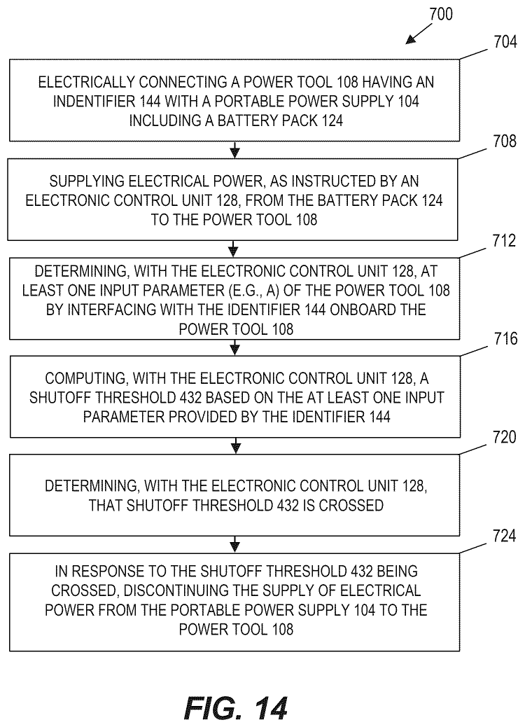

Similar to the auto-shutoff method 500, the power tool assembly 100 may use the identifiers 144a, 144b of the pumps 108a, 108b to avoid dry pumping operations with entirely distinct shutoff threshold curves 432, 436 calculated for each pump 108a, 108b. FIG. 14 illustrates an auto-shutoff method 700 (i.e., an auto-shutoff scheme) that includes a step 704 whereby a power tool 108 (e.g., the small pump 108b) is electrically connected to the portable power supply 104 via the cord 112. In step 708, electrical power is supplied, as instructed by the electronic control unit 128 to the power tool 108 (e.g., the small pump 108b). In step 712, the electronic control unit 128 determines the characteristic of the power tool 108 (e.g., the size of the impeller of the connected small pump 108b) by interfacing with the identifier 144 (e.g., the identifier 144b) of the power tool 108 (e.g., the small pump 108b). In step 716, the electronic control unit 128 computes a shutoff threshold curve 432 based on at least one input parameter (e.g., coefficient A) provided by the identifier 144. The shutoff threshold curve 432 may be based on two or more input parameters (e.g., A, B, and C). The shutoff threshold curve 432 may be unrelated to any baseline shutoff threshold curve or any threshold curve (e.g., 436) associated with different previously connected power tool(s) (e.g., the large pump 108a). The shutoff threshold curve 432 may be computed by inputting the input parameter(s) into a mathematical equation (shutoff threshold curve =Ax\hat{ }2+Bx+C). In step 720, the electronic control unit 128 determines that, while operating the motor 136 (e.g., 136b) at the set speed (e.g., 3000 rpm), the power output to the motor 136 (e.g., motor 136b) by the power supply 104 crosses the shutoff threshold curve 432. In response to the shutoff threshold 432 being crossed, at step 724, the electronic control unit 128 discontinues (i.e., inhibits, stops) the supply of electrical power from the portable power supply 104 to the power tool 108 (e.g., small pump 108b).

FIG. 15 illustrates an exemplary second order polynomial shutoff threshold curves 432, 436, for the large pump 108a and the small pump 108b, respectively. Equations noting the coefficients of the second order polynomial are copied on FIG. 15. In the illustrated embodiment, the large pump 108a may be connectable to the portable power supply 104, and the electronic control unit 128 can interface with the identifier 144a, with the electronic control unit 128 calculating numerical values from the identifier 144a and corresponding with the coefficients (A, B, C) of the second order polynomial. The coefficients are then utilized by the electronic control unit 128 to generate the shutoff threshold curves 432, 436.

In the illustrated embodiment, for the large pump 108a, the coefficient A (shutoff threshold curve =Ax\hat{ }2+Bx+C) is approximately 0.0002, the coefficient B is approximately −0.6625, and the coefficient C is approximately 631.25. Other values for the coefficients A, B, C are possible. For example, the identifier 144b of the small pump 108b, with the small pump 108b connected to the portable power supply 104, may cause the control unit 128 to calculate different numeral values for the coefficients (A, B, C). In the illustrated embodiment, for the small pump 108b, coefficient A is approximately 8e−05, the coefficient B is approximately −0.144, and the coefficient C is approximately 66.

FIG. 16 illustrates use of a different exponential mathematical equation for computing shutoff threshold curves 432, 436. The exponential equation is simply an alternative mathematical equation to the second order polynomial of FIG. 15 and for utilizing input parameters (D, E, shutoff threshold curve=D*e\hat{ }(E*x)). In the illustrated embodiment, for the large pump 108a, the coefficient D is approximately 23.214, and the coefficient E is approximately 0.0011. Other values for the coefficients D, E are possible. For example, the identifier 144b of the small pump 108b, with the small pump 108b connected to the portable power supply 104, may cause the control unit 128 to calculate different numeral values for the coefficients (D, E). In the illustrated embodiment, for the small pump 108b, coefficient D is approximately 11.184, the coefficient E is approximately 0.0011.

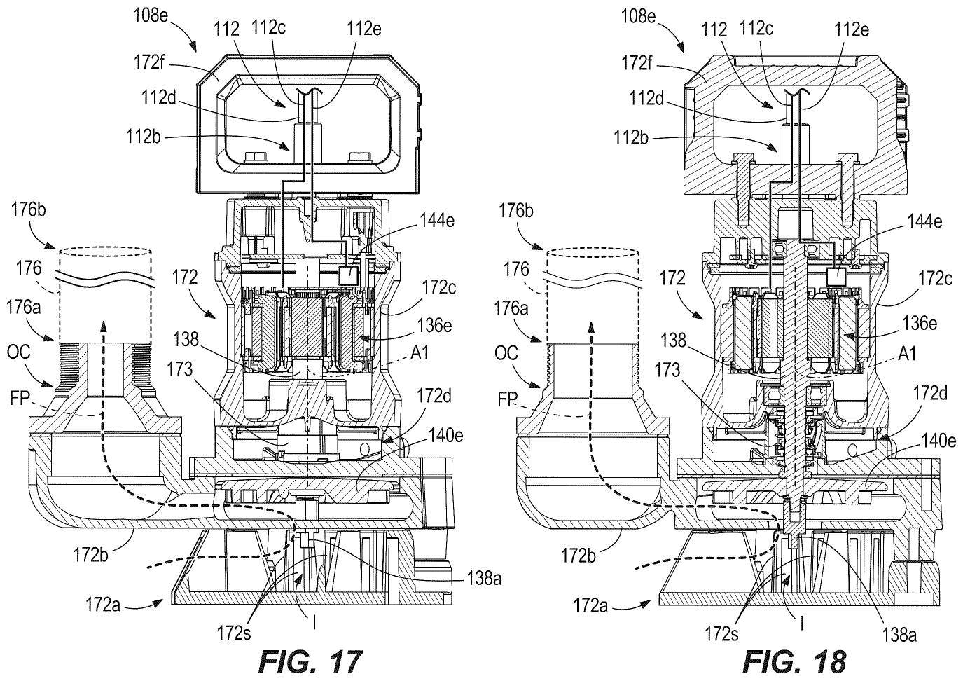

FIG. 1 further illustrates another pump 108e known as a trash pump. The trash pump 108e is further illustrated in detail in FIGS. 17 and 18. Components of the trash pump 108e that are similar to the pumps 108a, 108b are identified with corresponding alphanumeric reference numerals. For example, the trash pump 108e includes a motor 136e, impeller 140e, and identifier 144e similar to that of the submersible pumps 108a, 108b. The trash pump 108e is connectable to the portable power supply 104 to function as another type of power tool 108 similarly to the pumps 108a, 108b and concrete vibrator heads 108c, 108d as part of the power tool assembly 100. The trash pump 108e may be subject to the above-described tool identification schemes 200, 600 and auto-shutoff methods 500, 700. However, some aspects of the trash pump 108e differ from the pumps 108a, 108b as described below.

FIG. 17 is a cross-sectional view of the trash pump 108e passing through the impeller shroud 172b thereof and illustrating an exterior of the oil lifter 173 and the full flow path FP through the impeller shroud 172b. FIG. 18 is a cross-sectional view of the trash pump 108e passing through the rotor shaft 138 thereof and illustrating an interior of the oil lifter 173. In contrast to the submersible pumps 108a, 108b, the trash pump 108e lacks an outer housing 172e, and the outlet connector OC is coupled to the impeller shroud 172b rather than an outer housing 172e. In the trash pump 108e, the motor sub-housing 172c is open to the surroundings. The flow path FP of the trash pump 108e does not pass along an exterior of the motor sub-housing 172c. Rather, the flow path FP passes through the impeller shroud 172b to the outlet connector OC, and ultimately the tube 176. The sizing and operating characteristics of the trash pump 108e may be adjusted to comport to the small trash pump 108f as described with regard to the small submersible pump 108b.

In contrast to the inlet strainer 172a of the pumps 108a, 108b including holes, the inlet strainer 172a of the trash pump 108e includes vertically extending slots 172s to permit fluid communication between the inlet I and the impeller shroud 172b. The slots 172s are elongated in a direction parallel to the axis A1, separated from one another in a circumferential direction about axis A1, and sized to inhibit ingress of large solid debris carried by the working fluid from entering the inlet strainer 172a. The inlet I as formed by the slots 172s may be positioned entirely below the impeller 140e (as viewed in FIGS. 17 and 18) such that the flow path FP does not require fluid and debris to be passed downward between the inlet I and the impeller 140e. Depending on the water level WL, the motor sub-housing 172c may or may not be submersed in the trash solid-fluid mixture. During typical operation of the trash pump 108e, the working fluid may have a relatively high (e.g., equal to or greater than 50%) concentration of solid debris passable through the inlet strainer 172a and into the impeller shroud 172b. The solid debris and working fluid mixture may be pumped (as illustrated in FIGS. 17 and 18) to and beyond the output end 176b of the tube 176 to the ground G above the hole level H1.

The trash pump 108e includes a stirrer 138a at a tip end of the rotor shaft 138. The stirrer 138a is positioned downstream of the inlet I, and upstream of the impeller 140e, the impeller shroud 172b, and the outlet connector OC. The stirrer 138a rotates with the rotor shaft 138 during operation of the motor 136e to agitate and inhibit clogging of the solid debris either at the inlet I or in the impeller shroud 172b. The illustrated stirrer 138a is shaped as a generally planar plate, although other stirrers 138a may be non-planer in shape.

The outlet connector OC of the trash pump 108e may be oriented in parallel with the axis A1. However, as with the submersible pumps 108a, 108b, the outlet connector OC may be oriented in any desired manner relative to the housing 172 such as a direction transverse to or perpendicular to the axis A1.

The trash pump 108e may pump water and solid debris, and have physical dimensions in accordance with those listed below. The inlet I and inlet strainer 172a may permit debris of less than approximately 0.28 inches (approximately 7.11 millimeters) in diameter to pass therethrough and into the working fluid entering the impeller shroud 172b. The trash pump 108e may be operable at a speed of approximately 3400 rpm; however other trash pumps may differ in their operating speeds and operating speed ranges (i.e., low speed, high speed). The trash pump 108e may include a motor 136e rated for 1 horsepower (i.e., 745.7 watts). The trash pump 108e may be operable to pass a flow rate of at least 30 gallons per minute (gpm, approximately 110 liters per minute, lpm), optionally at least 40 gpm (approximately 150 lpm), optionally at least 50 gpm (approximately 190 lpm), and optionally at least 55 gpm (approximately 210 lpm). The trash pump 108e may have a maximum flow rate between 50 gpm and 60 gpm (between approximately 190 lpm and approximately 230 lpm). In the illustrated embodiment, the trash pump 108e has a maximum flow rate of 55 gpm (approximately 210 lpm). The trash pump 108e may include a 2 inch (5.08 centimeter) diameter outlet connector OC and tube 176. The cord 112 may have a length of 32 feet (approximately 9.8 meters). The trash pump 108e may have a max head height of greater than 50 feet (approximately 15 meters) and less than 75 feet (approximately 23 meters). The trash pump 108e has a max head height of 62 feet (approximately 19 meters). The exemplary trash pump 108e has physical length, width, and height respectively of 185 millimeters, 290 millimeters, and 389 millimeters; and a weight of 37 pounds (approximately 16.7 kilograms). Sizing and operating parameters of the trash pump 108e may be adjusted to meet demand and use case of the power tool assembly 100. Alternatively, the small trash pump 108f or either submersible pump 108a, 108b may be connected to the portable power supply 104 to meet demand and use case of the power tool assembly 100.

Various features of the invention are set forth in the following claims.

1. A power supply configured to supply electrical power to a connected power tool having a motor and an identifier representative of a characteristic of the connected power tool, the power supply comprising:
a housing including a battery receptacle configured to receive a battery pack; and
an electronic control unit positioned within the housing, the electronic control unit configured to interface with the identifier to determine the characteristic of the connected power tool and, in response to the determined characteristic, supply electrical power from the battery pack to the motor at an associated power output.

2. The power supply of claim 1, wherein the connected power tool is alternately a first power tool and a second power tool,
wherein the first power tool is a first type of power tool that has a first identifier representative of a first characteristic thereof,
wherein the second power tool is the same first type of power tool and has a second identifier representative of a second characteristic thereof, and
wherein the electronic control unit is configured to:
determine the characteristic of the connected power tool based on the identifier of the connected power tool;
supply a first electrical power output to the first power tool when the first power tool is the connected power tool; and
supply a different second electrical power output to the second power tool when the second power tool is the connected power tool.

3. The power supply of claim 1, wherein the connected power tool is alternately a first power tool and a second power tool,
wherein the first power tool is a first type of power tool that has a first identifier representative of a first characteristic thereof,
wherein the second power tool is a different second type of power tool and has a second identifier representative of a second characteristic thereof, and
wherein the electronic control unit is configured to:
determine the characteristic of the connected power tool based on the identifier of the connected power tool;
supply a first electrical power output to the first power tool when the first power tool is the connected power tool; and
supply a different second electrical power output to the second power tool when the second power tool is the connected power tool.

4. The power supply of claim 1, wherein the identifier is an integrated circuit.

5. The power supply of claim 1, wherein the identifier a resistor.

6. The power supply of claim 1, wherein:
the connected power tool includes a first wireless communication device,
the electronic control unit includes a second wireless communication device, and
the first wireless communication device and the second wireless communication device are configured to communicate with one another to provide the interface between the electronic control unit and the identifier.

7. The power supply of claim 6, further comprising a third wireless communication device in wireless communication with both the first wireless communication device and the second wireless communication device,
wherein the third wireless communication device is configured to communicate with the first wireless communication device and the second wireless communication device to facilitate the interface between the electronic control unit and the identifier.

8. The power supply of claim 1, wherein the electronic control unit is configured to supply electrical power from the battery pack to the motor based on the characteristic of any connected power tool having the identifier without requiring prior connection between the power tool and the electronic control unit or modification of the electronic control unit.

9. The power supply of claim 1, further comprising a strap coupled to the housing.

10. The power supply of claim 1, further comprising a screen mounted on the housing and in electrical communication with the electronic control unit, the screen configured to display information relating to the determined characteristic.

11. The power supply of claim 1, further comprising a control panel actuatable by a user to adjust the supply of electrical power from the battery pack to the motor.

12. The power supply of claim 1, wherein the electronic control unit scales supply electrical power based on the determined characteristic to supply scaled power output to the motor.

13. A power tool assembly comprising:
a power tool including:
a motor coupled to a working element, and
an identifier representative of a characteristic of the power tool;
a power supply including:
a housing having a battery receptacle configured to receive a battery pack, and
an electronic control unit positioned within the housing, the electronic control unit configured to interface with the identifier to determine the characteristic of the power tool and, in response to the determined characteristic, supply electrical power from the battery pack to the motor at an associated power output, and
an electrical cord connecting the power supply to the power tool, the electrical cord configured to transmit the electrical power from the power supply to the motor.

14. The power tool assembly of claim 13, wherein the power tool is a pump and the working element is an impeller configured to drive working fluid.

15. The power tool assembly of claim 14, wherein the power tool is a concrete vibrator head including a housing within which the motor is positioned, and the working element is an eccentric mass configured to cause the housing to vibrate.

16. The power tool assembly of claim 13, further comprising a strap coupled to the housing.

17. The power tool assembly of claim 13, wherein the electronic control unit scales supply electrical power based on the determined characteristic to supply scaled power output from the power supply to the motor.

18. The power tool assembly of claim 13, wherein the power supply further comprises a control panel actuatable by a user to adjust the supply of electrical power from the battery pack to the motor.

19. The power tool assembly of claim 13, wherein:
the power tool includes a first wireless communication device,
the electronic control unit includes a second wireless communication device, and
the first wireless communication device and the second wireless communication device are configured to communicate with one another to provide the interface between the electronic control unit and the identifier.

20. The power tool assembly of claim 19, further comprising a third wireless communication device in wireless communication with both the first wireless communication device and the second wireless communication device,
wherein the third wireless communication device is configured to communicate with the first wireless communication device and the second wireless communication device to facilitate the interface between the electronic control unit and the identifier.

21.-33. (canceled)
